(19) United States
(12) Patent Application Publication
(10) Pub. No.: US 2005/0047584 A1
(43) Pub. Date: Mar. 3, 2005

(54) System and method for customized intelligent contact routing

(75) Inventors: William Walker Franklin, Richmond, VA (US); Marion Roamadison Cabble III, Richmond, VA (US); Eric Gregory Cunningham, Richmond, VA (US); Christopher Alan Palmer, Mechanicsville, VA (US)

Correspondence Address: BAKER BOTTS L.L.P., 2001 ROSS AVENUE, SUITE 600, DALLAS, TX, 75201-2980, US

(73) Assignee: Capital One Financial Corporation

(21) Appl. No.: 10/649,043

(22) Filed: Aug. 26, 2003

(51) Int. Cl. H04M 3/00; H04M 5/00

(52) U.S. Cl. 379/265.13

(57) ABSTRACT

In accordance with a particular embodiment of the present invention, a system and method for customized intelligent contact routing is provided. The customized intelligent contact routing system includes an intelligent contact manager and a classification engine coupled with the intelligent contact manager. The classification engine is operable to determine a classification to be used in handling a contact by applying a set of classification rules. The intelligent contact manager is operable to select an appropriate service and an appropriate target to deliver that service for the contact given the classification determined by the classification engine.

### TECHNICAL FIELD OF THE INVENTION

The present invention relates in general to the field of customer relations management and, in particular, to a system and method for customized intelligent contact routing.

### BACKGROUND OF THE INVENTION

Customer relations management (CRM) systems, such as automated call routing systems, are used in a variety of fields where customer service is often a priority. In CRM systems employed in call centers, contacts are normally received by a voice response unit (VRU), which solicits a variety of information from the customer. This information is typically used to identify the customer and the reason for the contact. The contact is then passed to an automatic call distributor (ACD), which distributes the contact to an appropriate agent, or agent queue (AQ), associated with the ACD to deliver the desired service. To facilitate this distribution of the contact from the VRU to the ACD, some CRM systems also employ an intelligent contact manager (ICM). The ICM takes the contact from the VRU and distributes it to one of a plurality of ACDs based upon a variety of factors, such as the desire to minimize call wait times or to pick an agent or group particularly well-suited to handle a particular task. Other clients, such as web servers and desktop applications, may also be serviced by the ICM.

As the contact is passed between the various components of the CRM system, a variety of contact handling rules are employed to ultimately direct the contact to an agent that can deliver the desired service. These rules can generally be broken into two main types: classification rules, which identify the type of customer and/or transaction, and targeting rules, which direct the contact to the correct system resources for service delivery. Typically, these rules are hosted and executed throughout the CRM system. Furthermore, the classification rules are often bound up in the rules that direct targeting. Therefore, the classification and targeting rules are often commingled and spread out throughout the CRM system.

### SUMMARY OF THE INVENTION

In accordance with a particular embodiment of the present invention, a system and method for customized intelligent contact routing is provided. The customized contact routing system comprises an intelligent contact manager and a classification engine coupled with the intelligent contact manager. The classification engine is operable to determine a classification to be used in handling a contact by applying a set of classification rules. The intelligent contact manager is operable to select an appropriate service and an appropriate target to deliver that service for the contact based upon the classification determined by the classification engine.

A technical advantage of particular embodiments of the present invention includes a customized intelligent contact routing system that employs a centralized classification engine to assign classifications to customer contacts. This centralized classification engine reduces the number of systems that assign classifications that have to be maintained and periodically synchronized. The centralized classification engine also allows for a high degree of consistency of customer experiences across several customer contact points.

Another technical advantage of particular embodiments of the present invention includes a centralized classification engine that employs a robust scripting language that allows for complex classification rules. Unlike some ICMs or other network components that offer rudimentary classification functionality, particular embodiments of the present invention employ a robust scripting language that is well-suited for capturing complex classification rules that may be developed by a user. In particular embodiments, this may include nested, modular, and/or flexible code constructs.

Yet another technical advantage of particular embodiments of the present invention includes a classification engine and corresponding classification database whose classification rules and classification data can be updated in real-time or near real-time. This allows rules and data changes to be made instantaneously, rather than having to wait for a scheduled service period.

Still another technical advantage of particular embodiments of the present invention includes a classification engine and corresponding classification database that allow users the ability to update a limited set of the classification rules and data. This allows non-IT users to update selected aspects of the classification rules and data without jeopardizing the integrity of the entire set of classification rules and data.

Other technical advantages will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and its advantages, reference is now made to the following descriptions, taken in conjunction with the accompanying drawings, in which:

FIG. 1 illustrates a customized intelligent contact routing system in accordance with a particular embodiment of the present invention;

FIG. 2 illustrates a classification engine in accordance with a particular embodiment of the present invention;

FIG. 3 illustrates a flowchart of the logical interrelation of classification, service selection, targeting, and service delivery that occurs in particular embodiments of the present invention; and

FIG. 4 illustrates a flowchart of a method of customized intelligent contact routing in accordance with a particular embodiment of the present invention.

### DETAILED DESCRIPTION OF THE INVENTION

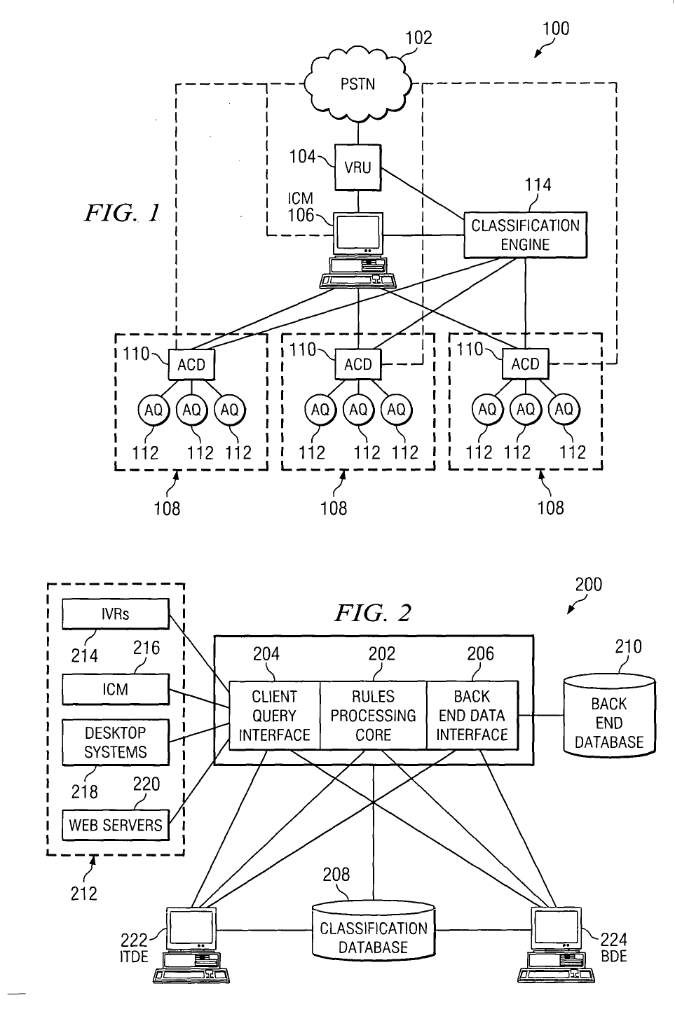

In accordance with a particular embodiment of the present invention, FIG. 1 illustrates customer relations management (CRM) system 100. CRM system 100 is a customized intelligent call routing system that employs a dedicated classification engine that assigns classifications to the various contacts handled by the system. By centralizing the classification of the CRM system's contacts in a single classification engine, CRM system 100 offers the ability to employ uniform classification rules across the entire CRM system and realize a greater degree of consistency in customer experiences across multiple customer contact channels.

As shown in FIG. 1, contacts enter CRM system 100 in the form of incoming calls from public switched telephone network (PSTN) 102. Thus, CRM system 100, as illustrated in FIG. 1, is essentially an automatic call routing system. However, it should be recognized that the teachings of the present invention are not limited to automatic call routing systems, but also extend to other CRM systems including those which accept contacts through customer service web servers and desktop applications, as well as through other customer contact clients. Further, contacts may enter CRM system 100 from networks other than PSTN 102. These may include cellular network, personal communication system (PCS) networks, satellite networks, Internet-based networks, and other applicable networks.

A notification of an incoming contact, or call, is received from PSTN 102 by intelligent contact manager (ICM) 106, which is operable to control the contact flow throughout CRM system 100. Upon this notification, ICM 106 directs PSTN 102 to send the incoming contact call to voice response unit (VRU) 104.

From PSTN 102, incoming contacts enter VRU 104, which is also known as an interactive voice response (IVR) unit. VRU 104 is operable to solicit information from the incoming contact through a series of voice prompts. Examples of the types of information that may be solicited may include customer identifications, account numbers, and/or the reason for the contact. This information, along with the contact, is then forwarded to ICM 106. As will be discussed in more detail below, in addition to soliciting information from a caller, VRU 104 is also operable to provide services to a caller, such as reading an account balance to the caller or informing the caller about various account services.

ICM 106, which may include a number of commercially available ICM units, such as the Cisco®/GeoTel® ICM, is operable to distribute incoming contacts to one or more individual call centers 108. As will be discussed in more detail below, this distribution, or targeting, may be based on several factors, such as the desire to balance the load experienced by the various resources of the CRM system or to send a contact to an agent or group that is particularly well-suited to accommodate the customer's needs.

Each call center 108 comprises an automatic call distributor (ACD) 110, which distributes calls to one or more agents or agent queues (AQ) 112, for the agents to deliver the desired service to the incoming call. Like ICM 106, each ACD 110 is also coupled with PSTN 102 and is able to receive data communication, as well as voice communication.

To facilitate the determination of which call center 108 and agent queue 112 the incoming contact is sent to, CRM system 100 assigns a classification to each contact. As will be discussed in more detail below, this classification is assigned through a series of complex rules based upon the attributes of the contact. To facilitate this process, CRM system 100 includes classification engine (CE) 114. CE 114 is preferably a server coupled with ICM 106, VRU 104, ACDs 110, and/or other customer contact clients in CRM system 110. CE 114 acts as a single repository of the classification rules employed in CRM system 100, helping users realize a consistency in customer experiences across a number of customer contact channels.

A better understanding of the classification engine is available by making reference to FIG. 2, which illustrates CE 200 in accordance with a particular embodiment of the present invention.

As shown in FIG. 2, CE 200 comprises rules processing core 202, client query interface 204, and back end data interface 206.

Processing core 202 is the heart of CE 200. Processing core 202, which may utilize a number of different rules management systems, such as Blaze Advisor™ or ILOG®, applies a series of classification rules to assign a classification to the contact. By using a dedicated rules management system on CE 200, the classification rules employed by the CRM system may take on a greater level of complexity than those employed by less sophisticated systems. For example, rules processed by processing core 202 may be nested and/or allow for the use of modular and/or flexible code constructs. This allows for the greater customization of the customer experience, incorporating more of the information known about the customer and allowing businesses to offer greater functionality through their CRM systems. At the same time, the use of central processing core 202 and the associated classification rules also reduces the number of systems administrators and users must be trained on in order to update and modify the classification rules for the CRM system.

To help determine the appropriate classification to assign to a given contact, CE 200 must be given certain information about the contact, such as the customer and account information corresponding to the contact. Much of this information is stored in back end, or enterprise, databases that are already part of the CRM system. Therefore, CE 200 includes back end data interface 206, which allows CE 200 to access data stored in back end, enterprise databases, such as back end database 210. Examples of such an interface include a C++ API interface, among others.

Particular embodiments of the present invention also consider other data not typically stored in the back end, or enterprise, databases. An example of this data might include “pre-processed” lists of accounts that meet certain candidate criteria. Another example might include analysis data that simply does not belong in the normal transaction-oriented back end data systems. Therefore, this data, collectively referred to as classification data, is stored in a classification database 208 that is also coupled with CE 200. Since it is often desirable to be able to update classification database 208 with as little latency as possible, particular embodiments of database 208 allow real-time, or near real-time, updates of classification data. To simplify the process of updating the classification data, particular embodiments of database 208 also allow batch-style updates. This contributes much to the ease of handling and modifying the data held by database 208.

Before CE 200 can assign a classification, CE 200 must first be queried for one. Therefore, as mentioned above, CE 200 also includes client query interface 204. Client query interface 204 allows CE 200 to receive requests for classification from the various customer contact clients 212 coupled to CE 200. Examples of these clients 212 include IVRs 214, ICM 216, desktop systems 218, and web servers 220. In particular embodiments of the present invention, this interface may present the same type of interface that other systems of record present, so as to minimize the cost of implementing CE 200 in the CRM system. Examples of languages, standards, and/or products that may be used for this interface include MQSeries® and XML, although other languages are also possible.

As shown in FIG. 2, CE 200 also includes IT development environment (ITDE) 222 and business development environment (BDE) 224. ITDE 222 and BDE 224 allow users to implement changes to rules and data stored in CE 200 and the corresponding classification database 208. ITDE 222 allows administrators, or IT users, the unrestricted ability to implement changes to the classification rules used by CE 200 and the data held in classification database 208. BDE 224 also offers the ability to implement changes to CE 200 and database 208; however, unlike ITDE 222, BDE 224 is restricted as to the particular types of changes it can make. This prevents a casual business user from making inadvertent changes to the entire CRM system.

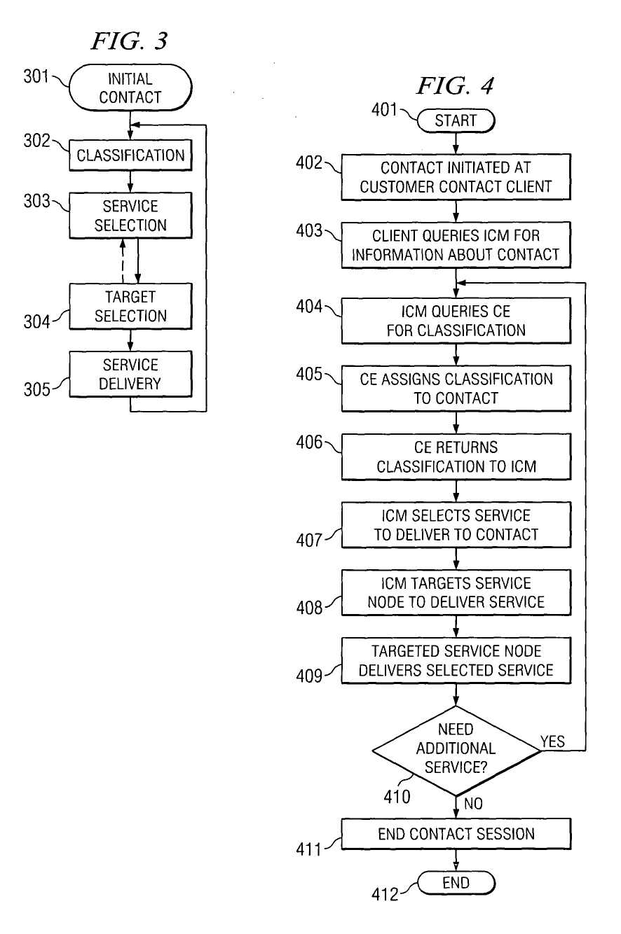

FIG. 3 illustrates the logical interrelation between the steps in handling a contact and ultimately delivering the appropriate service to the contact. As shown in FIG. 3, this comprises essentially four steps: classification, service selection, targeting, and service delivery.

In this process, the contact is initially received in block 301. This can take place a number of ways, such as a call being received at a VRU, a customer logging into a customer service website, or a customer service representative accessing a desktop application.

The contact is then classified in block 302. Classification is the act of deciding what strategy is to be used in dealing with a contact. The classification, or strategy, is not so specific as to identify every possible contingency for the management of a contact, as that would require a virtually infinite number of classifications. The classification is, however, specific enough to limit the options available so that contact handling can be constructed out of modular and/or flexible code constructs.

To assign a classification to each call or contact, the classification engine of the present invention applies a complex set of classification rules to the data known about the contact. Ideally, each call or contact receives a classification very early in the contact. Examples of factors that could be considered in making a classification decision include account status and/or customer account information, such as the cost of the customer's accounts, revenue generated from the customer's accounts, offers available to the customer, account usage, previous transactions, tests that may apply to the customer, marketing strategies that may apply to the customer, number dialed or other method of contact, events that occur during the course of the call or other method of contact, and the geographic location of the customer. It should be recognized, however, that this list of factors is not all-inclusive, and is presented for illustrative purposes only.

Once the contact has been classified, the service to be provided to the contact is selected in block 303. The service selection may be made at any number of points, including the VRU, ICM, and/or a customer service web server or desktop application. In particular embodiments of the present invention utilizing an ICM, many of these service selection decisions will be made at the ICM. Examples of services that may be selected include telling a customer his or her balance, opening a new account, or terminating an existing account, among others.

Once the contact has been classified and the service selected, target selection takes place in block 304. Targeting is the act of selecting a “service node” to handle the contact, such as a particular VRU, ACD, or agent queue. Targeting decisions are driven by a variety of factors. These may include the desire to balance call load among VRUs or agents, or selecting an agent group that is particularly well-suited for a particular task or type of contact. The act of selecting a target for the contact requires knowledge about what service needs to be provided by the target, but it need not include the decision about what service needs to be offered. Such a determination would preferably be considered during service selection, rather than during targeting. Sometimes, the availability of various target service nodes also affects the service selection decision. For example, if multiple services need to be performed and not all service nodes are available, the service that can be performed by an available target may be selected to be performed first. Therefore, a dotted line is shown connecting block 304 to block 303 to illustrate this relationship.

After targeting, the targeted service node delivers the selected service in block 305. After the service has been delivered, a new service may be selected to be performed, which means another service selection/targeting/service delivery iteration. However, additional information may be gathered during the service delivery, such as during the creation or termination of an account. This may lead to the need to reclassify the contact before additional services are delivered. Therefore, the classification of the contact is re-evaluated in block 302 prior to entering another iteration of service selection, targeting, and service delivery.

An example of an implementation of the classification/selection/targeting/delivery process discussed above is shown in FIG. 4, which illustrates a flowchart of a method of customer relations management in accordance with a particular embodiment of the present invention.

After the flowchart begins in block 401, a contact is initiated at a customer contact client, such as a VRU, website, or desktop application. After identifying the customer and/or account that is the subject of the contact, such as through the use of automatic number identification (ANI) or by soliciting the information from the customer, the customer contact client queries the ICM in block 403 for any additional information the ICM may have about the customer and/or account.

Then, in block 404, the ICM queries the CE for a classification for the contact. In determining the classification, the CE applies a set of classification rules to the information known about the contact. Based upon the application of these classification rules, the CE assigns a classification to the contact in block 405 and returns the classification to the ICM in block 406.

With the classification determined, in block 407 the ICM then selects the appropriate service to deliver to the contact. This service selection is largely driven by the classification, or contact strategy, assigned to the contact. As mentioned above in regard to FIG. 3, the service selection and targeting decisions may be closely related, since service decisions may depend on the availability of targets to provide services. If several services are valid in a contact strategy, the decision about which service to provide may depend on which target is least busy at that point in time. Additionally, the service selection rules may limit the number of available targets.

Nonetheless, after a service selection is made, in block 408 the ICM targets an appropriate service node, or “target,” which delivers the selected service to the contact in block 409. This is typically a presentation layer exercise, provided by a customer-facing component such as a VRU, web server, or desktop application. An example of such a service delivery would be providing the customer's current balance, either by having a VRU play the balance over the phone, having an agent look up the balance in a customer service desktop application and read it to the customer, or having a customer service web server display the balance on the customer's web browser.

After the selected service is delivered to the contact, the determination is made in decision block 410 whether or not an additional service is needed. If not, the contact session is terminated in block 411, prior to the flowchart terminating in block 412. If, however, an additional service is desired or required, the contact is redirected back to block 404, where the ICM queries the CE for an updated classification for the contact. This ensures that the classification is accurate, taking into account any changes that may have occurred as a result of the services delivered previously in the contact session. This cycle of classification, service selection, targeting, and service delivery continues until no additional services are required. At that point, the process terminates in block 412.

By centralizing the classification of contacts in a CRM system into a central rules-based classification engine, particular embodiments of the present invention may offer numerous technical advantages. For example, particular embodiments of the present invention offer a greater degree of consistency of customer experiences across the multiple customer contact channels incorporated into a CRM system.

Another technical advantage of particular embodiments of the present invention includes the ability to persist a classification and the information known about a contact throughout the lifetime of the contact within the CRM system. This eliminates, or at least alleviates, the need to repeatedly query the customer for the same information throughout the contact session. This both eliminates redundant information gathering and saves customer time.

Particular embodiments of the present invention also allow for the use of complex classification rules that may be difficult to employ in existing CRM systems and components. Examples of these include nested, modular, and/or flexible code constructs. This greater complexity in the classification rules allows for greater customization of the customer experience, incorporating more of the information known about the customer and/or his or her accounts.

Although particular embodiments of the method and apparatus of the present invention have been illustrated in the accompanying drawings and described in the foregoing detailed description, it will be understood that the invention is not limited to the embodiments disclosed, but is capable of numerous rearrangements, modifications, and substitutions without departing from the spirit of the invention as set forth and defined by the following claims.

1. A customized intelligent contact routing system, comprising:
an intelligent contact manager; and
a classification engine coupled with the intelligent contact manager;
wherein the classification engine is operable to determine a classification to be used in handling a contact by applying a set of classification rules; and
wherein the intelligent contact manager is operable to select an appropriate service and an appropriate target for the contact based upon the classification determined by the classification engine.

2. The system of claim 1, wherein the classification is selected from a list of predetermined classifications.

3. The system of claim 1, wherein the classification corresponds to a call type.

4. The system of claim 1, further comprising:
a client query interface operable to receive a request for classification from a customer contact client, query the classification engine for the classification, and return the classification to the customer contact client.

5. The system of claim 1, further comprising:
a classification database operable to store data used by the classification engine to determine the classification.

6. The system of claim 5, wherein the data comprises pre-processed lists of accounts that meet predetermined candidate criteria.

7. The system of claim 5, wherein the classification database is operable to be updated in real-time.

8. The system of claim 5, wherein the classification database is operable to be updated in batch-style loads.

9. The system of claim 5, further comprising:
a restricted development environment operable to update selected aspects of the classification database and classification rules.

10. The system of claim 5, further comprising:
an unrestricted development environment operable to update all aspects of the classification database and classification rules.

11. The system of claim 1, further comprising:
a back end database operable to store information about customers and accounts.

12. A method for customized intelligent contact routing, comprising:
receiving, at a classification engine, a request from a customer contact client for classification of a contact;
applying a predetermined set of classification rules to data known about the contact to determine a classification for the contact; and
returning the classification to the customer contact client.

13. The method of claim 12, further comprising:
querying a classification database for data known about the contact; and
receiving, from the classification database, data known about the contact.

14. The method of claim 12, further comprising:
querying a back end database for data known about the contact; and
receiving, from the back end database, data known about the contact.

15. A method of customized intelligent contact routing, comprising:
assigning a classification to a contact at a classification engine;
selecting a service to provide to the contact based upon the classification;
targeting a service node to provide the selected service to the contact; and
delivering the selected service to the contact at the targeted service node.

16. The method of claim 15, wherein selecting a service to provide to the contact based upon the classification is performed by an intelligent contact manager.

17. The method of claim 15, wherein targeting a service node to provide the selected service to the contact is performed by an intelligent contact manager.

18. The method of claim 15, wherein the classification is based upon a customer account status.

19. The method of claim 15, wherein the classification is based upon customer account information.

20. The method of claim 15, wherein the classification is based upon a previous customer transaction.

21. The method of claim 15, wherein the classification is based upon a call type.
